(19) United States
(12) Patent Application Publication
(10) Pub. No.: US 2018/0073940 A1
(43) Pub. Date: Mar. 15, 2018

(54) DEFORMATION DETECTION SENSOR AND PRODUCTION OF THE SAME

(71) Applicant: TOYO TIRE & RUBBER CO., LTD., Itami-shi, Hyogo (JP)

(72) Inventors: Takeshi Fukuda, Itami-shi, Hyogo (JP); Takahiro Ohta, Itami-shi, Hyogo (JP)

(73) Assignee: TOYO TIRE & RUBBER CO., LTD., Itami-shi, Hyogo (JP)

(21) Appl. No.: 15/555,134

(22) PCT Filed: Mar. 2, 2016
(86) PCT No.: PCT/JP2016/056485

§ 371 Date: Sep. 1, 2017

(30) Foreign Application Priority Data
Apr. 9, 2015 (JP) 2015-080329

(51) Int. Cl. G01L 1/12; B60R 21/015; B60N 2/00

(52) U.S. Cl. CPC G01L 1/12; B60N 2/002; B60R 21/01516

(57) ABSTRACT

The present invention provides a deformation detection sensor which combines a magnetic resin dispersing a magnetic filler in a resin with a magnetic sensor, of which stability of detection property is highly enhanced.

The present invention thus provides a deformation detection sensor which comprises:
a cushion pad which comprises a magnetic resin, in which a magnetic filler is contained, and a polymer foam in which the magnetic resin is included, and
a magnetic sensor that detects a magnetic change caused by a deformation of the cushion pad,
wherein the magnetic resin has an elastic modulus of 0.1 to 10 MPa, and a production thereof.

### FIELD OF THE INVENTION

The present invention is related to a deformation detection sensor, in particular a deformation detection sensor used for a car seat, and a production method thereof.

### BACKGROUND OF THE INVENTION

There has been practically used a warning system which detects whether a person is sit on a seat in a vehicle, such as an automobile and then alerts if the person does not couple a seat belt. The warning system generally gives off an alert when it detects the sitting of the person and simultaneously detects not coupling the seat belt. The apparatus generally comprises a sitting sensor which detects whether a person is sitting on a seat and a sensor which detects not coupling the seat belt with a buckle although the person is seated, which gives off an alert when the uncoupling of the seat belt is detected. The sitting sensor necessitates high durability because it must detect a person sitting down many times. It is also necessary that, when a person is seated, the person does not feel the sensation of any foreign object in the seat.

JP 2012-108113 A (Patent Document 1) discloses a sitting sensor equipped in a seat, detecting the sitting of a person, which comprises electrodes facing with each other in a cushion material and detects an electric contact of the electrodes. This sensor employs an electrode and should equip wiring. The wiring can be disconnected by receiving a large displacement and gives some problems in durability. In addition, the electrode is generally made of metallic substance which may create a sensation of a foreign object. Even if the electrode is not metallic, the feeling of a foreign object would easily generate based on the other substances.

JP 2011-255743 A (Patent Document 2) discloses an electrostatic capacitance-type sitting sensor which comprises sensor electrodes facing with each other, between which dielectric substance is inserted, and an electrostatic capacitance-type sensor that measures an electrostatic capacity between the electrodes. This sensor also employs electrodes and should equip wiring, which gives rise to durability problems as same with Patent Document 1. It is also difficult to prevent a sensation of a foreign object.

JP 2007-212196 A (Patent Document 3) discloses a load detection device for a vehicle seat, which comprises a magnetism generator equipped with a displaceable flexible element and a magnetic sensor, equipped with a fixing element of a flame, having a magnetic impedance element that detects a magnetic field generated by the magnetism generator. Since the magnetism generator includes a magnet having a specified size in this device, it is quite difficult to dispose the magnetism generator near a surface of a cushion material without any foreign object sensation. In order to avoid the foreign object sensation, it is considered that the magnetism generator is disposed inside the cushion material, but this leads to the deterioration of detection accuracy.

JP 2006-014756 A (Patent Document 4) discloses a biosignal detection device which comprises a permanent magnet and a magnetic sensor. Since the device also employs the permanent magnet which would give a foreign object sensation, it is difficult to place the device near a surface of the cushion material. The displacement of the device inside the cushion material leads to the deterioration of detection accuracy.

### SUMMARY OF THE INVENTION

The present inventors have already proposed a deformation detection sensor wherein a magnetic resin, in which magnetic filler is dispersed in a resin, is inserted into a polymer foam, in order to enhance the durability of the deformation detection sensor and to obtain a seat which does not provide any foreign object sensation, but maintaining stability and sensibility at a wide temperature range (e.g. −20° C. to +80° C.) is difficult. As the results of the intense study, the present inventors have found that, by controlling a glass transition temperature of the magnetic resin to not more than −30° C., excellent stability and sensibility can maintain even such wide temperature ranges, thus the present invention having been accomplished.

Accordingly, the present invention provides a deformation detection sensor which comprises:

a cushion pad which comprises a magnetic resin, in which a magnetic filler is contained, and a polymer foam in which the magnetic resin is included, and

a magnetic sensor that detects a magnetic change caused by a deformation of the cushion pad,

wherein the magnetic resin has a glass transition temperature (Tg) of not more than −30° C.

The present invention also provides a method for producing a deformation detection sensor, comprising the steps of:

a step of dispersing a magnetic filler in a resin precursor solution,

a step of curing the resin precursor solution to form a magnetic resin having a glass transition temperature (Tg) of not more than −30° C.,

a step of placing the magnetic resin in a mold for a polymer foam,

a step of pouring a polyurethane raw material of the polymer foam into the mold to foam, whereby the magnetic resin is integrated with the polymer foam, and

a step of combining the cushion pad with a magnetic sensor that detects a magnetic change caused by a deformation of the cushion pad.

It is preferred that the magnetic resin has a storage modulus ratio E′(20° C./−20° C.) (i.e. a ratio of storage modulus at 20° C. (E′(20° C.))/storage modulus at −20° C. (E′(−20° C.)) of not less than 0.2.

It is also preferred that the magnetic resin and the polymer foam are made of polyurethane.

It is further preferred that the magnetic resin and the polymer foam are adhered by self-adhesion.

It is more preferred that the polyurethane for forming the magnetic resin comprises a main chain type silicone-containing polyol.

It is further more preferred that the main chain type silicone-containing polyol has a number average molecular weight (Mn) of 1,000 to 5,000 and is contained in an amount of 20 to 80% by weight based on the resin of the magnetic resin.

It is also preferred that the cushion pad is for a vehicle and the deformation to be detected occurs by a sitting of a person.

According to the present invention, by controlling a glass transition temperature of the magnetic resin to not more than −30° C., the magnetic resin does not change its performances even at a wide temperature range as −20° C. to +80° C. and shows excellent stability and sensibility. Thus, the deformation detection sensor of the present invention exhibits excellent detection ability to magnetic changes derived from deformations of the polymer foam at wide temperature ranges.

Since the magnetic filler is dispersed in the resin for the magnetic resin of the present invention, it can hardly provide a foreign object sensation and shows comfortable to sit in when it is used for a seat in a vehicle, in comparison with that using a solid magnetic. In addition, as the magnetic sensor detects a magnetic change caused by the magnetic filler contained in the magnetic resin, the magnetic sensor can be disposed separately with a certain distance apart from the magnetic resin and can be placed without wiring to connect with an electrode, which does not show any problems, such as cutting wire or poor durability. Further, since wiring to connect with an electrode is not necessary, it is not necessary to place any foreign object in the polymer foam and a production of the deformation detection sensor would become easily.

### BRIEF DESCRIPTION OF THE DRAWINGS

FIG. 1 is a schematic sectional view which shows an embodiment that the deformation detection sensor of the present invention is applied to a seat for a vehicle.

FIG. 2 shows a schematic perspective view of the cushion pad of the present invention.

### DETAILED DESCRIPTION OF THE PREFERRED EMBODIMENTS

The present invention will be explained in detail by referring the drawings.

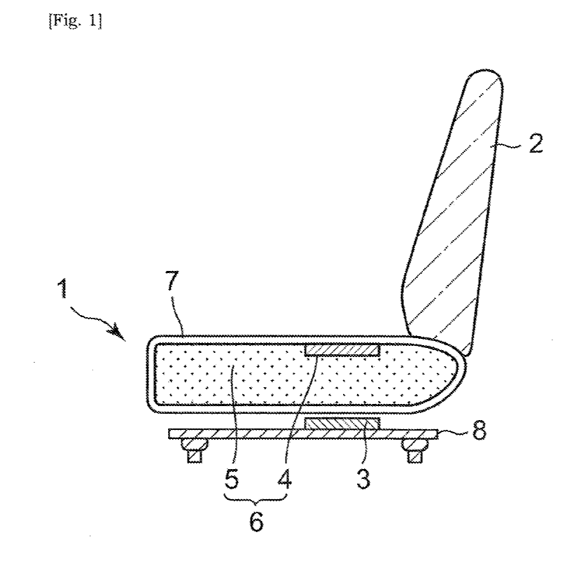

FIG. 1 is a schematic sectional view which shows an embodiment that the deformation detection sensor of the present invention is applied to a seat for a vehicle.

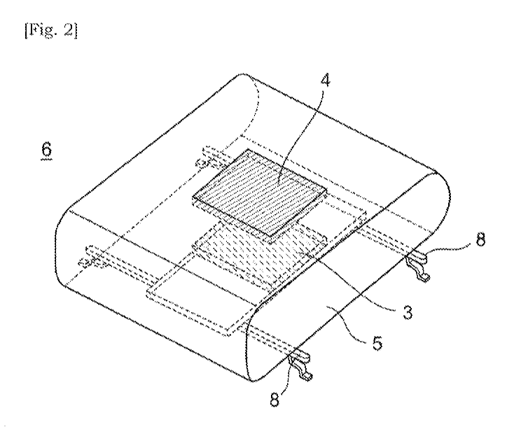

FIG. 2 shows a schematic perspective view of the cushion pad of the present invention.

The seat for a vehicle using the deformation detection sensor of the present invention is basically composed of a sitting portion 1, a backseat portion 2 and a magnetic sensor 3. The sitting portion 1 is composed of a cushion pad 6 which comprises a magnetic resin 4 and a polymer foam 5; and an outer skin 7 covering the cushion pad 6. The magnetic resin 4 is disposed in layer in a portion of the sitting surface in the polymer foam 5. It is preferred that the magnetic sensor 3 is fixed to a pedestal 8 supporting the seat for vehicle. The pedestal 8 is fixed to a car body in the case of a car, which is not shown in the figures.

FIG. 2 shows a perspective view of the cushion pad 6 of the present invention, which is composed of the magnetic resin 4 and the polymer foam 5, and it further shows the pedestal 8 and the magnetic sensor 3 mounting on the pedestal 8. The magnetic resin 4 is disposed on an uppermost portion of the polymer foam, which can highly receive the deformation when a person is sitting on the seat. FIG. 2 does not show the outer skin 7 which is present on the cushion pad 6. The outer skin 7 is generally made of leather, fabric, synthetic resin or the like, which is not limited thereto.

The magnetic resin 4 contains a magnetic filler dispersed therein, which has magnetism by way of a magnetization method or another method. When a person sits on the sitting portion 1, the cushion pad 6 is deformed and the magnetic field is changed thereby. The change of the magnetic field is detected by the magnetic sensor 3 to inspect the person sitting on the seat. In FIGS. 1 and 2, the polymer foam 6 which contains the magnetic resin 4 is present near the buttock of the person and, when the person is sitting, the sensor inspects it and, for example, when the person does not wear a seat belt, it alerts to the person. In addition, the cushion pad 6 may be used as a backrest which contacts a backside of a person. When the polymer foam 6 is used as a backrest, the magnetic sensor can detect a posture of the sitting person.

Magnetic Resin

The term “magnetic resin” employed in the present specification means a resin in which a magnetic filler (an inorganic filler having magnetism) is dispersed.

The magnetic filler generally includes rare earth-based, iron-based, cobalt based, nickel-based or oxide-based filler, which can be used in the present invention. The rare earth-based magnetic filler is preferred because it shows high magnetism, but is not limited thereto. Neodymium-based magnetic filler is more preferred. A shape of the magnetic filler is not limited, but includes spherical, flake, needle, columnar or indefinite shape. The magnetic filler may preferably have an average particle size of 0.02 to 500 μm, preferably 0.1 to 400 μm, more preferably 0.5 to 300 μm. If it has an average particle size of less than 0.02 μm, the magnetic properties of the magnetic filler become poor and if it has an average particle size of more than 500 μm, the mechanical properties (e.g. brittleness) of the magnetic resin become poor.

The magnetic filler may be introduced into the resin after it is magnetized, but it is preferred that the magnetic filler is magnetized after it is introduced into the resin, because the polarity of the magnetic filler can be easily controlled and the detection of magnetism can be easily carried out.

The magnetic resin of the present invention is characterized by having a glass transition temperature (Tg) of not more than −30° C. The magnetic resin preferably has a glass transition temperature (Tg) of −80° C. to −30° C. In addition, it is preferred that the magnetic resin has a storage modulus ratio E′(20° C./−20° C.) (i.e. a ratio of storage modulus at 20° C. (E′(20° C.))/storage modulus at −20° C. (E′(−20° C.)) of not less than 0.2, in order to detect the deformation of a cushion pad with excellent sensitivity event at a wide temperature range, especially at a lower temperature range.

The resin for the magnetic resin can employ any resin which falls in glass transition temperature within the above mentioned range. The resin may include thermoplastic elastomer, thermosetting elastomer or a mixture thereof. Examples of the thermoplastic elastomers are styrene based thermoplastic elastomer, polyolefin based thermoplastic elastomer, polyurethane based thermoplastic elastomer, polyester based thermoplastic elastomer, polyamide based thermoplastic elastomer, polybutadiene based thermoplastic elastomer, polyisoprene based thermoplastic elastomer, fluororubber based thermoplastic elastomer and the like. Examples of the thermosetting elastomer are diene based synthetic rubber, such as polyisoprene rubber, polybutadiene rubber, styrene-butadiene rubber, polychloroprene rubber, nitrile rubber, and ethylene-propylene rubber; non-diene based synthetic rubber, such as ethylene-propylene rubber, butyl rubber, acryl rubber, polyurethane rubber, fluororubber, silicone rubber, and epichlorohydrin rubber; natural rubber; and the like. Among them, thermosetting elastomer is preferred, because it can be used in a long period of time during which damage or fatigue of the magnetic resin can be inhibited. More preferred is polyurethane elastomer (also mentioned herein as polyurethane rubber) or silicone elastomer (also mentioned herein as silicone rubber).

The polyurethane elastomer can be obtained by reacting an active hydrogen-containing compound with an isocyanate component. In the case where the polyurethane elastomer is employed as resin component, an active hydrogen-containing compound is mixed with a magnetic filler, into which an isocyanate component is added and mixed to form a mixture solution. In addition, polyurethane elastomer can also be prepared by mixing an isocyanate component with a magnetic filler, into which an active hydrogen-containing compound is added and mixed to form a mixture solution. The resulting mixture solution is poured in a mold which has been treated with a releasing agent, and then heated to a curing temperature to cure, thus obtaining a polyurethane elastomer. In the case of silicone elastomer, a precursor of silicone elastomer is combined with a magnetic filler and mixed, followed by heating it to cure, thus obtaining a silicone elastomer. When forming the mixture solution, a solvent may be added thereto, if necessary.

The isocyanate component to be employed for the polyurethane elastomer can be anyone that has been employed in the field of polyurethane. Examples of the isocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, and m-xylylene diisocyanate; an aliphatic diisocyanate, such as ethylene diisocyanate, 2,2,4-trimethylhexamethylene diisocyanate, and 1,6-hexamethylene diisocyanate; an alicyclic diisocyanate, such as 1,4-cyclohexane diisocyanate, 4,4′-dicyclohexylmethane diisocyanate, isophorone diisocyanate, and norbornane diisocyanate. The compounds can be used alone or in combination of two or more compounds thereof. In addition, the isocyanate can be modified by urethane modification, allophanate modification, biuret modification, isocyanulate modification or the like. Preferred isocyanate components are 2,4-toluene diisocyanate, 2,6-toluene diisocyanate, and 4,4′-diphenylmethane diisocyanate, and more preferred are 2,4-toluene diisocyanate and 2,6-toluene diisocyanate.

The active hydrogen-containing compound can be anyone that has been employed in the field of polyurethane. It is, however, preferred in the present invention that a silicone-containing polyol is used as the active hydrogen-containing compound, because the glass transition temperature (Tg) of the magnetic resin is easily controlled to not more than −30° C. and a change of elastic modulus of the magnetic resin can be reduced even at either a reduced temperature or an elevated temperature in comparison with ambient temperature. The silicone-containing polyol is a compound having at least two active hydrogen groups at its terminal and a silicone portion (Si—O—Si) in its main chain or side chain. In the present invention, either a polyol having silicone portion in main chain (main chain type silicone-containing polyol) or a polymer having silicone portion in side chain (side chain type silicone-containing polyol) can be employed. The polyol having silicone portion in main chain (main chain type silicone-containing polyol) is, however, preferred, because it does not develop phase separation in polyurethane elastomer and the resulting magnetic resin would keep adhesive property.

In the case where the silicone-containing polyol is employed as the active hydrogen-containing compound, it is preferred that the silicone-containing polyol has a number average molecular weight (Mn) of 1,000 to 5,000. Number average molecular weights of less than 1,000 do not improve low temperature properties sufficiently and those of more than 5,000 make silicone domains too big and has high tendency of peeling, thus reducing property stability. In addition, it is preferred that a content of the silicone-containing polyol is within a range of 10 to 80% by weight based on a weight of whole matrix. The contents of the silicone-containing polyol of less than 20% by weight make the glass transition temperature to not more than −30° C. and those of more than 80% by weight would deteriorate adhesiveness with the polymer foam due to silicone components, thus resulting in poor property stability.

In the present invention, the active hydrogen-containing compounds may not only be the silicone-containing polyol as mentioned above, can also be a compound which has been known in the field of polyurethane. Examples of the active hydrogen-containing compounds are a polyether polyol, such as polytetramethylene glycol, polypropylene glycol, polyethylene glycol and a copolymer of polypropylene oxide and polyethylene oxide; a polyester polyol, such as polybutylene adipate, polyethylene adipate, and 3-methyl-1,5-pentane adipate; a polyester polycarbonate polyol, such as a reaction product of a polyester glycol (e.g. polycaprolactone polyol and polycaprolactone) and an alkylene carbonate; a polyester polycarbonate polyol obtained by reacting ethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof.

In addition to the above-mentioned high molecular weight polyol component, the active hydrogen-containing component can also include a low molecular weight polyol, such as ethylene glycol, 1,2-propylene glycol, 1,3-propylene glycol, 1,4-butanediol, 1,6-hexanediol, neopentyl glycol, 1,4-cyclohexane dimethanol, 3-methyl-1,5-pentanediol, diethylene glycol, triethylene glycol, 1,4-bis(2-hydroxyethoxy)benzene, trimethylolpropane, glycerin, 1,2,6-hexane triol, pentaerythritol, tetramethylol cyclohexane, methyl glucoside, sorbitol, mannitol, dulcitol, sucrose, 2,2,6,6-tetrakis(hydroxymethyl)cyclohexanol, and triethanolamine; and a low molecular weight polyamine, such as ethylenediamine, tolylenediamine, diphenylmethanediamine, diethylenetriamine and the like. These compounds can be used alone or a combination of two or more compounds thereof. A polyamine, including 4,4′-methylenebis(o-chloroaniline)(MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-dimethyltolucne-2,4-diamine, 3,5-diethyltoluene-2,6-diamine, triethyleneglycol-di-p-aminobenzoate, polytetramethyleneoxide-di-p-aminobenzoate, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 4,4′-diamino-3,3′-diethyldiphenylmethane, 4,4′-diamino-3,3′-diethyl-5,5′-dimethyldiphenylmethane, 4,4′-diamino-3,3′-diisopropyl-5,5′-dimethyldiphenylmethane, 4,4′-diamino-3,3′,5,5′-tetraethyldiphenylmethane, m-xylylenediamine, N,N′-di-sec-butyl-p-phenylenediamine, m-phenylenediamine, p-xylylenediamine; and the like, may also be added thereto. Preferred active hydrogen containing-compounds include polyethylene glycol, polypropylene glycol, a copolymer of propylene oxide and ethylene oxide, and 3-methyl-1,5-pentane diadipate and more preferred are polypropylene glycol and a copolymer of propylene oxide and ethylene oxide.

When the magnetic resin is made of polyurethane elastomer, the magnetic resin preferably has an NCO index of 0.3 to 1.2, more preferably 0.5 to 1.1, more preferably 0.7 to 1.05. If NCO index is less than 0.3, the magnetic resin tends not to cure sufficiently. If NCO index is more than 1.2, the elastic modulus tends to become high and the detection accuracy tends to be lowered.

An amount of the magnetic filler in the magnetic resin can preferably be 1 to 450 parts by weight, more preferably 2 to 400 parts by weight, based on 100 parts by weigh of the resin. Amounts of less than 1 part by weight make it difficult to detect magnetic changes and those of more than 450 parts by weight make the resin brittle and do not obtain the desired properties.

In the present invention, the magnetic resin can also be adhered to the polymer foam using a double-side adhesive tape or an adhesive agent, but it is preferably integrated with the polymer foam by self-adhesion. If it is self-adhered, the magnetic resin does not peel off from the polymer foam easily and shows excellent durability. Since the magnetic resin is flexible, the cushion pad is soft and shows good sitting comfort. The self-adhesion between the magnetic resin and the polymer foam can be generated by chemical bond or hydrogen bond derived from urethane group and hydroxyl group present in the molecular of the resin.

It is preferred that the magnetic resin has a thickness in non-compressed conditions of 300 to 5000 μm, preferably 400 to 4500 μm, more preferably 500 to 4000 μm. Thicknesses of less than 300 μm make the magnetic resin brittle when sufficient amount of filler is added therein and deteriorate handling ability and those of more than 4500 μm have a tendency to provide a foreign object sensation given by the magnetic resin to the person sitting.

The magnetic resin may be non-foamed and does not have any foamed cell, but the magnetic resin may be foamed and has foamed cells, in view of stability, enhanced detection accuracy of the magnetic sensor and weight reduction. A foamed body can be a foamed resin, but a thermosetting resin foam is preferred because of physical properties, such as compression set and the like. The thermosetting resin foam can be polyurethane resin foam, silicone resin foam and the like, but polyurethane resin foam is more preferred. The polyurethane resin foam can be obtained from the isocyanate component and active hydrogen-containing compound as mentioned above.

In the present invention, a peripheral portion of the magnetic resin may be sealed by a sealing material as far as it does not deteriorate the flexibility of the magnetic resin. The sealing material can be thermoplastic resin, thermosetting resin or a mixture thereof. The thermoplastic resin includes styrene based thermoplastic elastomer, polyolefin based thermoplastic elastomer, polyurethane based thermoplastic elastomer, polyester based thermoplastic elastomer, polyamide based thermoplastic elastomer, polybutadiene based thermoplastic elastomer, polyisoprene based thermoplastic elastomer, fluoride based thermoplastic elastomer, ethylene ethylacrylate copolymer, ethylene vinylacetate copolymer, polyvinylchloride, polyvinylidene chloride, chlorinated polyethylene, fluoride resin, polyamide, polyethylene, polypropylene, polyethylene terephthalate, polybutylene terephthalate, polystyrene, polybutadiene or the like. The thermosetting resin includes, for example, diene based synthetic rubber, such as polyisoprene rubber, polybutadine rubber, styrene-butadiene rubber, polychloroprene rubber and acrylonitrile butadiene rubber; non-diene based rubber, such as ethylene-propylene rubber, ethylene-propylene-diene rubber, butyl rubber, acryl rubber, polyurethane rubber, fluororubber, silicone rubber and epichlorohydrine rubber; natural rubber; polyurethane resin; silicone resin; epoxy resin; or the like. When the sealing material is thermoplastic resin, thermosetting resin or a mixture thereof, it can be used in the form of film. The film can be a laminated film, a metal foil (e.g. aluminum foil) or a film having vapor deposited film composed of a film on which a metal is vapor deposited. The sealing material has technical effects that inhibit the formation of rust of the magnetic filler in the magnetic resin.

Process for Producing the Deformation Detection Sensor

The present invention also provides a method for producing a deformation detection sensor, comprising the steps of:

a step of dispersing a magnetic filler in a resin precursor solution,

a step of curing the resin precursor solution to form a magnetic resin having a glass transition temperature (Tg) of not more than −30° C.,

a step of placing the magnetic resin in a mold for a polymer foam,

a step of pouring a polyurethane raw material of the polymer foam into the mold to foam, whereby the magnetic resin is integrated with the polymer foam, and

a step of combining the cushion pad with a magnetic sensor that detects a magnetic change caused by a deformation of the cushion pad.

The magnetic resin, as mentioned above, can be produced by formulating the magnetic filler in the resin precursor solution and reacting in the mold to form the magnetic resin having a glass transition temperature of not more than −30° C. The obtained magnetic resin is placed in a mold for the polymer foam into which a raw material for the polymer foam is poured. The raw material for the polymer foam is then foamed to obtain a cushion pad in which the magnetic resin is integrated with the polymer foam.

In the magnetic resin, it is preferred that the magnetic filler is localized near one of surfaces. In addition, it is also preferred that the localized surface of the magnetic filler constitutes its sitting surface. The magnetic resin can be strongly adhered to the polymer foam by the magnetic filler being localized in the magnetic resin.

Polymer Foam

The polymer foam can be obtained by foaming the raw solution of the polymer foam. The polymer foam can be a general resin foam and among them thermosetting resin foam, such as polyurethane resin foam or silicone resin foam, is preferred. In the case of polyurethane resin foam, the raw solution generally comprises a polyisocyanate component, a polyol and an active hydrogen-containing compound such as water. The polyisocyanate component and active hydrogen-containing compound are listed hereinafter.

The polyisocyanate component can be anyone that has been used in the field of polyurethane. Examples of the polyisocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, m-xylylene diisocyanate and the like. It can also be polynuclear compounds of diphenylmethane diisocyanate (crude MDI). The polyisocyanate compound can further be an aliphatic diisocyanate, such as ethylene diisocyanate, 2,2,4-trimethylhexamethylene diisocyanate and 1,6-hexamethylene diisocyanate; an alicyclic diisocyanate, such as 1,4-cyclohexane diisocyanate, 4,4′-dicyclohexylmethane diisocyanate, isophorone diisocyanate, norbornane diisocyanate; and the like. These can be used alone or in combination with two or more isocyanates thereof. In addition, the isocyanate can be modified by urethane modification, allophanate modification, biuret modification, isocyanulate modification or the like.

The active hydrogen-containing compound can be anyone that has generally been used in the field of polyurethane. Examples of the active hydrogen-containing compounds are a polyether polyol, such as polytetramethylene ether glycol, polypropylene glycol, polyethylene glycol and a copolymer of propylene oxide and ethylene oxide; a polyester polyol, such as polybutylene adipate, polyethylene adipate, and 3-methyl-1,5-pentane adipate; a polyester polycarbonate polyol, such as a reaction product of polyester glycol (e.g. polycaprolactone polyol or polycaprolactone) and alkylene carbonate; a polyester polycarbonate polyol obtained by reacting polyethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof. The concrete examples of the active hydrogen-containing compounds include, for example EP 3028, EP 3033, EP 828, POP 3128, POP 3428 and POP 3628, commercially available from Mitsui Chemical Inc.; and the like.

When producing the polymer foam, other components, such as crosslinking agent, foam stabilizer, catalyst and the like can be employed and they are not limited thereto.

The crosslinking agent may include triethanolamine, diethanolamine or the like. The foam stabilizer may include SF-2962, SRX-274C, 2969T and the like, available from Dow Corning Toray Co., Ltd. Examples of the catalysts are Dabco 33LV available from Air Products Japan Co., Ltd., Toyocat ET, SPF2, MR available from Tosoh Corporation, and like.

In addition, an additive, such as water, toner, flame retardant or the like can be suitably employed if necessary.

Examples of the flame retardants are CR 530 or CR 505 available from Daihachi Chemical Industry Co., Ltd.

Deformation Detection Sensor

The cushion pad as obtained above can be combined with the magnetic sensor to obtain the deformation detection sensor of the present invention. The cushion pad includes a magnetic resin layer in a part thereof and is deformed by a person sitting on the cushion pad to change magnetism. The magnetic change is detected by the magnetic sensor to find the person sitting on the seat. In the case of a seat belt wearing detection sensor for a car, after a passenger is sit on a seat, an alert gives off while the seat belt is not coupled and once the seat belt is coupled, the sensor detects the coupling of the seat belt and the alert goes off.

In the producing method of the deformation detection sensor of the present invention, the magnetic resin can be present either an upper surface of the polymer foam or a lower surface of the polymer foam. The magnetic resin may also be present in or inside the polymer foam.

The magnetic sensor can be anyone that has generally been used for detecting magnetism. It may include a magnetoresistive element (e.g. a semiconductor magnetoresistive element, an anisotropic magnetoresistive element (AMR), a gigantic magnetoresistive element (GMR) or a tunnel magnetoresistive element (TMR)), a hall element, an inductor, an MI element, a flux gate sensor and the like. The hall element is preferred because it has excellent sensitivity widely or extensively.

In addition, the deformation detection sensor of the present invention can be used for different applications other than cushion pads for vehicles, such as a hand or a skin of a robot, a surface pressure distribution of a bed or the like, a road surface condition or an air pressure of a tire, an exercise condition of a living body (such as motion captures, respiratory conditions, relaxed states of muscle, and the like), an invasion into a keep-out area, a foreign object of a slide door.

### EXAMPLES

The present invention is further explained based on the following examples which, however, are not construed as limiting the present invention to their details.

### Preparation Example 1 (Synthesis of Prepolymer a Having Terminal Isocyanate Group)

A reaction vessel was charged with 85.2 parts by weight of polyol A (a polyoxypropylene glycol obtained by adding propylene oxide to a glycerin catalyst, OH value 56, Functionality 3; EX-3030 available from Asahi Glass Co., Ltd.) and was dehydrated at a reduced pressure with mixing for one hour. The reaction vessel was then changed to nitrogen atmosphere. Next, 14.8 parts by weight of toluene diisocyanate (2,4 configuration=80%, NCO %=48.3%; available from Mitsui Chemicals Inc.) was added to the reaction vessel and reacted for 5 hours at a temperature of 80° C. in the reaction vessel to synthesize a prepolymer A having a terminal isocyanate group (NCO %=3.58%).

### Preparation Example 2 (Synthesis of Prepolymer B Having Terminal Isocyanate Group)

A reaction vessel was charged with 85.2 parts by weight of polyol C (a polyether-modified main chain type reactive silicone, OH value 56, Functionality 2; X-22-4272 available from Shin-Etsu Chemical Co., Ltd.) and was dehydrated at a reduced pressure with mixing for one hour. The reaction vessel was then changed to nitrogen atmosphere. Next, 14.8 parts by weight of toluene diisocyanate (2,4 configuration=80%, NCO %=48.3%; available from Mitsui Chemicals Inc.) was added to the reaction vessel and reacted for 5 hours at a temperature of 80° C. in the reaction vessel to synthesize a prepolymer B having a terminal isocyanate group (NCO %=3.58%).

### Example 1

Separately, 31.0 parts by weight of toluene was mixed with a mixture of 106.5 parts by weight of polyol C (a polyether-modified main chain type reactive silicone, OH value 56, Functionality 2; X-22-4272 available from Shin-Etsu Chemical Co., Ltd.) and 0.24 parts by weight of bismuth octylate (PUCAT 25 available from Nihon Kagaku Sangyo Co., Ltd.), into which 206.5 parts by weight of neodymium based filler (NdFeB magnetic powder; available from Aichi Steel Co., Ltd. as MF-15P; average particle size 133 μm) was added, to form a filler dispersion. Separately, 100.0 parts by weight of the prepolymer A was mixed with 31.0 parts by weight of toluene to prepare a prepolymer solution. The prepolymer solution was added to the filler dispersion mentioned above and mixed using a planetary centrifugal mixer (available from Thinky Corporation) and defoamed. The reaction solution was added dropwise on a PET film having a spacer of 1.0 mm, which had been treated with a mold releasing agent, and was adjusted by a nip roller to a 1.0 mm thickness. It was then kept at 80° C. for 1 hour to cure to obtain a magnet filler dispersion resin. It was then magnetized at 2.0 T using a magnetizing apparatus (available from Tamakawa Co., Ltd.) to obtain a magnetic resin.

A silicone content (weight %) of the resulting magnetic resin was obtained from the following equation and the results are shown in Table 1.

Silicone content (wt %)−Amount of silicone-containing polyol (g)/Amount of magnetic resin without magnetic filler (g)×100

In addition, a glass transition temperature (Tg) and a storage modulus (E′) of the resulting magnetic resin were measured as described below. The results are shown in Table 1.

The glass transition temperature (Tg) and the storage modulus were measured using a dynamic viscoelasticity measuring device (available from Mettler-Toledo Company as DMA861e). The measuring conditions are as follow:

Measuring mode: Tensile mode

Frequency: 1 Hz

Temperature elevating rate: 2.5° C./min

Measuring temperature range: −100 to 100° C.

Shape of sample: length 19.5 mm, width 3.0 mm and height 1.0 mm

Note: Glass transition temperature was measured at peak top temperature (° C.) of tan δ.

Preparation of Magnetic Resin-Containing Polymer Foam (Cushion Pad)

Next, 60.0 parts by weight of a polypropylene glycol (available from Mitsui Chemicals Inc. as EP-3028; OH value 28), 40.0 parts by weight of a polymer polyol (available from Mitsui Chemicals Inc. as POP-3128; OH value 28), 2.0 parts by weight of diethanolamine (available from Mitsui Chemicals Inc.), 3.0 parts by weight of water, 1.0 part by weight of a foam stabilizer (available from Dow Corning Toray Co., Ltd. as SF-2962) and 0.5 parts by weight of an amine catalyst (available from Air Products Japan Co., Ltd. as Dabco 33LV) were mixed with stirring to obtain a mixture A which was controlled to a temperature of 23° C. Separately, a mixture of toluene diisocyanate and crude MDI (80/20 weight ratio; available from Mitsui Chemicals Inc. as TM-20; NCO %=44.8%) was controlled to a temperature of 23° C. to obtain a mixture B.

The magnetic resin obtained above was cut to 50 mm square and was placed on a desired position in a cavity of a square of 400 mm and a thickness of 70 mm in a mold and heated to a mold temperature of 62° C. Into the mold, a raw material obtained by mixing the mixture A with the mixture B so as to become NCO index=1.0 was poured using a high pressure foaming machine and foamed and cured at a mold temperature 62° C. for 5 minutes to obtain a magnetic resin-containing polymer foam (i.e. a cushion pad). The polymer foam was subjected to a determination of magnetic flux density change (Gauss) and property stability (%) as explained hereinafter. The results are shown in Table 1.

Average Magnetic Flux Density Change (Gauss)

A hall element (available from Asahi Kasei Microdevices Corporation as EQ-430L) was adhered to an acryl board and was then attached to a surface of the polymer foam opposite to the side of the magnetic resin in the obtained cushion pad. A pressure indenter having 40 mmφ was applied to a center portion of the magnetic resin at a pressure of 10 kPa to obtain a change (Gauss) of magnetic flux density by an output voltage change of the hall element. The measurement of the change of the magnetic flux density was conducted 5 times and its average was calculated therefrom. It was conducted at a temperature of −20° C. and 20° C.

Property Stability

The produced cushion pad was subjected to durability test of 500,000 times by using a pressure 30 kPa at a temperature of 40° C. and a humidity of 60%, and property stability was determined from the change of average magnetic flux density between before and after durability test. It was determined at a temperature of 20° C.

$$Property stability ( \% ) = \frac{\sqrt{\begin{matrix}( Average magnetic flux density change after durability test - \\ {Average magnetic flux density change before durability test )}^{2}\end{matrix}}}{Average magnetic flux density change before durability test} \times 100$$

### Examples 2 to 6 and Comparative Example 1

A cushion pad was prepared as generally described in Example 1, using the conditions of Table 1, and its change of magnetic flux density (Gauss) and property stability (%) were determined as generally described in Example 1, the results being shown in Table 1. Table 1 also shows NCO indexes, silicone content (wt %), type of silicone polymer (main chain type or side chain type), glass transition temperature of the magnetic resin, storage modulus ratio (E′(20° C./−20° C.)) and storage modulus at 20° C. (E′(20° C.).

The polyols employed are as follow:

Polyol A: a polyoxypropylene glycol obtained by adding propylene oxide to a glycerin catalyst, OH value 56, Functionality 3; EX-3030 available from Asahi Glass Co., Ltd.

Polyol B: a polyoxypropylene glycol obtained by adding propylene oxide to a glycerin catalyst, OH value 56, Functionality 2; EX-2020 available from Asahi Glass Co., Ltd.

Polyol C: a polyether-modified main chain type reactive silicone having a silicone molecular weight of 2,000, OH value 56, Functionality 2; X-22-4272 available from Shin-Etsu Chemical Co., Ltd.

Polyol D: a polyether-modified main chain type reactive silicone having a silicone molecular weight of 1,000, OH value 112, Functionality 2; FM-4114 available from JNC Corporation.

Polyol E: a polyether-modified main chain type reactive silicone having a silicone molecular weight of 5,000, OH value 22, Functionality 2; FM-4421 available from JNC Corporation.

Polyol F: a polyether-modified main chain type reactive silicone having a silicone molecular weight of 10,000, OH value 11, Functionality 2; FM-4425 available from JNC Corporation.

Polyol G: a polyether-modified side chain type reactive silicone having a silicone molecular weight of 1,000, OH value 112, Functionality 2; FM-DA11 available from JNC Corporation.

Polyol H: a polyether-modified side chain type reactive silicone having a silicone molecular weight of 5,000, OH value 22, Functionality 2; FM-DA21 available from JNC Corporation.

Polyol I: a polyoxypropylene glycol obtained by adding propylene oxide to a glycerin catalyst, OH value 168, Functionality 3; EX-1030 available from Asahi Glass Co., Ltd.

Comparative Example 1 did not employ the silicone-containing polyol, but employed the above-mentioned polyol I, of which the magnetic resin had a glass transition temperature (Tg) of −3.6° C. Table 1 also shows the results of the same evaluations as Example 1.

TABLE 1
Table 1

| | | | | | | | | | Comparative |
|---|---|---|---|---|---|---|---|---|---|
| | | | Examples | | | | | | Example |
| | | | 1 | 2 | 3 | 4 | 5 | 6 | 1 |
| Formulation | Prepolymer | Prepolymer A | 100.0 | 100.0 | 50.0 | 100.0 | 100.0 | 15.0 | 100.0 |
| | | Prepolymer B | | | 50.0 | | | 85.0 | |
| | Curing | Polyol A | | | | | | | |
| | agent | Polyol B | | 13.4 | | | 54.3 | | |
| | | Polyol C | 106.5 | | 71.7 | | | 106.5 | |
| | | Polyol D | | 38.2 | | | | | |
| | | Polyol E | | | 71.7 | | | | |
| | | Polyol F | | | | | 154.7 | | |
| | | Polyol G | | | | 37.8 | | | |
| | | Polyol H | | | | 61.7 | | | |
| | | Polyol I | | | | | | | 23.7 |
| | Filler | Neodymium type (MF-15P) | 206.5 | 151.6 | 243.3 | 199.5 | 309.0 | 206.5 | 123.7 |
| | Catalyst | Bismuth octylate | 0.24 | 0.18 | 0.29 | 0.24 | 0.37 | 0.25 | 0.15 |
| | Solvent | Toluene | 62.0 | 45.5 | 73.0 | 59.9 | 92.7 | 62.0 | 37.1 |

| | NCO index | | 0.80 | 0.95 | 0.85 | 0.85 | 1.00 | 0.80 | 1.20 |
|---|---|---|---|---|---|---|---|---|---|
| | Content of silicone-containing polyol (wt %) | | 51.6 | 25.2 | 76.4 | 49.9 | 50.0 | 86.6 | 0.0 |
| | Type of silicone-containing polyol | | Main | Main | Main | Side | Main | Main | — |
| | | | chain | chain | chain | chain | chain | chain | |
| Physical | Tg (° C.) | | −45.2 | −34.2 | −55.3 | −46.7 | −48.2 | −62.7 | −3.6 |
| properties | Storage modulus ratio E′(20° C./−20° C.) | | 0.54 | 0.27 | 0.64 | 0.47 | 0.46 | 0.72 | 0.04 |
| | Storage modulus E′ @20° C. (MPa) | | 1.38 | 2.68 | 0.89 | 1.96 | 0.76 | 1.24 | 3.18 |
| | Magnetic flux density | 20° C. | 3.6 | 3.1 | 3.9 | 3.4 | 3.7 | 4.2 | 2.7 |
| | change (Gauss) | −20° C. | 2.3 | 2.1 | 2.6 | 2.2 | 2.4 | 2.6 | 0.5 |
| | Property stability (%) | 20° C. | 8.6 | 7.7 | 9.4 | 9.5 | 10.3 | 10.8 | 11.4 |

As is apparent from Table 1, the examples of the present invention are excellent in magnetic flux density change (Gauss) and property stability. However, Comparative Example 1 does not employ silicone-containing polyol and shows poor magnetic flux density change at −20° C. and worst property stability.

In Example 4, the main chain type silicone was changed to the side chain type silicone. Since the side chain type silicone tended to generate phase separation, silicone domain was formed and the magnetic resin showed poor adhesiveness with the polymer foam so that the magnetic resin was getting unstuck partially. Accordingly, property stability was a little poor, but the cushion pad was usable. In Example 5, the silicone molecular weight of Example 1 was changed from 2,000 to 10,000. In the case where a molecular weight is made higher molecular weight, it is likely to generate phase separation. Accordingly, silicone domain was formed and the magnetic resin was getting unstuck partially. Thus, property stability was a little poor, but the cushion pad was usable. In Example 6, the silicone content of Example 1 was changed from 50% to 87%. Since the increased content of silicone component would make poor adhesive power with polymer foam and was getting unstuck partially. Accordingly, property stability was a little poor, but the cushion pad was usable.

### INDUSTRIAL APPLICABILITY

The deformation detection sensor of the present invention can be applied to a seat for vehicles and is excellent in durability so that it endures a long period of use. In addition, the deformation detection sensor of the present invention shows good stability and sensitivity in a wide temperature range (e.g. −20° C. to +80° C.) and does not show foreign sensitivity when sitting and is not so tired when sitting a long time.

### REFERENCE SIGNS LIST

1 Sitting portion
2 Backrest portion
3 Magnetic sensor
4 Magnetic resin
5 Polymer foam
6 Cushion pad
7 Outer skin
8 Pedestal

1-13. (canceled)

14. A deformation detection sensor which comprises:
a cushion pad which comprises a magnetic resin, in which a magnetic filler is contained, and a polymer foam in which the magnetic resin is included, and
a magnetic sensor that detects a magnetic change caused by a deformation of the cushion pad,
wherein the magnetic resin has a glass transition temperature (Tg) of not more than −30° C.

15. The deformation detection sensor according to claim 14, wherein the magnetic resin has a storage modulus ratio E′(20° C./−20° C.) (i.e. a ratio of storage modulus at 20° C. (E′(20° C.))/storage modulus at −20° C. (E′(−20° C.)) of not less than 0.2.

16. The deformation detection sensor according to claim 14, wherein the magnetic resin and the polymer foam are made of polyurethane.

17. The deformation detection sensor according to claim 15, wherein the magnetic resin and the polymer foam are made of polyurethane.

18. The deformation detection sensor according to claim 14, wherein the magnetic resin and the polymer foam are adhered by self-adhesion.

19. The deformation detection sensor according to claim 17, wherein the polyurethane for forming the magnetic resin comprises a main chain type silicone-containing polyol.

20. The deformation detection sensor according to claim 19, wherein the main chain type silicone-containing polyol has a number average molecular weight (Mn) of 1,000 to 5,000 and is contained in an amount of 20 to 80% by weight based on the resin of the magnetic resin.

21. The deformation detection sensor according to claim 14, wherein the cushion pad is for a vehicle and the deformation to be detected occurs by a sitting of a person.

22. A method for producing a deformation detection sensor, comprising the steps of:
a step of dispersing a magnetic filler in a resin precursor solution,
a step of curing the resin precursor solution to form a magnetic resin having a glass transition temperature (Tg) of not more than −30° C.,
a step of placing the magnetic resin in a mold for a polymer foam,
a step of pouring a polyurethane raw material of the polymer foam into the mold to foam, whereby the magnetic resin is integrated with the polymer foam, and
a step of combining the cushion pad with a magnetic sensor that detects a magnetic change caused by a deformation of the cushion pad.

23. The method for producing the deformation detection sensor according to claim 22, wherein the magnetic resin has a storage modulus ratio E′(20° C./−20° C.) (i.e. a ratio of storage modulus at 20° C. (E′(20° C.))/storage modulus at −20° C. (E′(−20° C.)) of not less than 0.2.

24. The method for producing the deformation detection sensor according to claim 22, wherein the magnetic resin and the polymer foam are made of polyurethane.

25. The method for producing the deformation detection sensor according to claim 24, wherein the magnetic resin and the polymer foam are adhered by self-adhesion.

26. The method for producing the deformation detection sensor according to claim 24, wherein the polyurethane for forming the magnetic resin comprises a main chain type silicone-containing polyol.

27. The method for producing the deformation detection sensor according to claim 26, wherein the main chain type silicone-containing polyol has a number average molecular weight (Mn) of 1,000 to 5,000 and is contained in an amount of 20 to 80% by weight based on the resin of the magnetic resin.
